(19) United States
(12) Patent Application Publication
(10) Pub. No.: US 2024/0031714 A1
(43) Pub. Date: Jan. 25, 2024

(54) SYSTEM FOR MOUNTING A TRANSDUCER ON AN INTERIOR TRIM PANEL OF A MOTOR VEHICLE

(71) Applicant: TREVES PRODUCTS, SERVICES & INNOVATION, Paris (FR)

(72) Inventors: Eric BRILLON, Paris (FR); Nicolas GUENAMANT, Paris (FR)

(21) Appl. No.: 18/266,067

(22) PCT Filed: Dec. 14, 2021
(86) PCT No.: PCT/EP2021/085705

§ 371 Date: Jun. 8, 2023

(30) Foreign Application Priority Data
Dec. 17, 2020 (FR) 2013542

(51) Int. Cl. H04R 1/02

(52) U.S. Cl. CPC H04R 1/025; H04R 2499/13

(57) ABSTRACT

The invention relates to a system for mounting a transducer on an interior trim panel of a motor vehicle. The system includes a base with a thread, and a peripheral receiving track and an interface attached to the transducer having a part for attaching to base. The interface has a reciprocal thread and a flexible collar forming a reciprocal track. The receiving track has a substantially flattened frusto-conical shape. Before screwing the receiving and reciprocal tracks together, the tracks are placed in contact along a circular peripheral line and, once the screwing has been carried out, the reciprocal track deforms in order to bear by its surface on the receiving track.

### CROSS-REFERENCE TO RELATED APPLICATIONS

This application claims the benefit of International application number PCT/EP2021/085705, filed Dec. 14, 2021 and French patent application number FR2013542, filed on Dec. 17, 2020, the entire contents of which are incorporated herein by reference.

### TECHNICAL FIELD

The invention relates to a system for mounting a transducer on an interior trim panel of a motor vehicle, and a panel equipped with a transducer mounted by said system.

### BACKGROUND

It is known to mount a transducer on an interior trim panel of a motor vehicle, in order to allow a signal from an amplifier to be propagated within a passenger compartment via said panel, the use of a transducer instead of a loudspeaker allowing in particular a weight and space saving.

Various problems appear when such an arrangement is implemented: simplifying the mounting, optimising the transmission of the signal from the amplifier to the panel (via the transducer), ensuring an easy dismounting of the transducer to replace it in the case of a defect.

### SUMMARY OF THE INVENTION

The invention aims at proposing a panel allowing reconciling these various requirements.

To this end, the invention proposes a system for mounting a transducer on an interior trim panel of a motor vehicle, said system comprising:
a base intended to be attached to said panel, said base being provided with a thread and a peripheral receiving track having, in axial view, a shape of a washer,
an interface made of moulded plastic material for attaching said transducer, said interface having:
a part for association with said transducer,
a part for attaching to said base, said part being provided with a reciprocal thread intended to be screwed onto said thread,
a flexible collar defining a reciprocal track having, in axial view, a shape similar to that of said receiving track,
   knowing that said receiving track is inscribed in a substantially flattened frusto-conical shape defined such that:
before screwing and when said tracks are brought into contact with each other, the contact is made along a circular peripheral line,
once the screwing has been carried out, said reciprocal track deforms to bear by its surface on said receiving track and to conform to the shape thereof, in order to allow an optimised transmission of the vibrations from said transducer to said panel.

It is specified here that the terms “axial” and “radial” are taken with reference to the axis along which the screwing of the interface (therefore of the transducer) takes place on the base.

With the proposed arrangement:
mounting the transducer on the panel is very simple since it comes down to screwing the transducer onto the base, the rotational travel being able to be defined, as will be seen later, of small angular sector in order to further simplify the mounting,
allows a continuous, and not punctual, surface contact between the base and the interface, this allowing optimising the transmission of the signal from the amplifier to the panel via the transducer,
finally, the transducer is easily removable from the panel, unlike embodiments where said transducer is directly mounted on said panel, for example by screwing or gluing.

### BRIEF DESCRIPTION OF THE DRAWINGS

Other particularities and advantages of the invention will appear in the following description, made with reference to the attached figures, in which:

FIG. 1 is a semi-exploded perspective schematic view, according to one embodiment, of a transducer provided with an interface and a base,

FIG. 2 represents the elements of FIG. 1 in detailed section, the interface being brought into contact with the base before screwing,

FIG. 3a is similar to FIG. 2 in simplified view,

FIG. 3b is similar to FIG. 3a by representing the transducer once screwed,

FIG. 4 is a schematic view in radial view of the base.

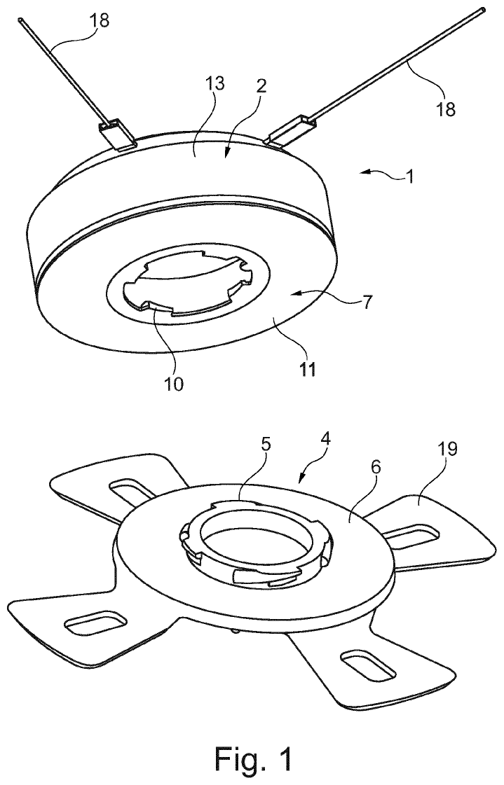

### DETAILED DESCRIPTION

With reference to the figures, a system 1 for mounting a transducer 2 is described—in particular electrodynamic or magnetostrictive—on an interior trim panel 3—for example a shelf covering a luggage compartment, a headliner, etc. . . . —of a motor vehicle, said system comprising:
a base 4—in particular made of moulded plastic material—intended to be attached to said panel, said base being provided with a thread 5—here external—and a peripheral receiving track 6 having, in axial view, a shape of a washer,
an interface 7 made of moulded plastic material for attaching said transducer, said interface having:
a part 8 for association with said transducer,
a part 9 for attaching to said base, said part being provided with a reciprocal thread 10—here internal—intended to be screwed onto said thread,
a flexible collar defining a reciprocal track 11 having, in axial view, a shape similar to that of said receiving track,
   knowing that said receiving track is inscribed in a substantially flattened frusto-conical shape defined such that:
before screwing and when said tracks are brought into contact with each other, the contact is made along a circular peripheral line 12,
once the screwing has been carried out, said reciprocal track deforms to bear by its surface on said receiving track and to conform to the shape thereof, in order to allow an optimised transmission of the vibrations from said transducer to said panel.

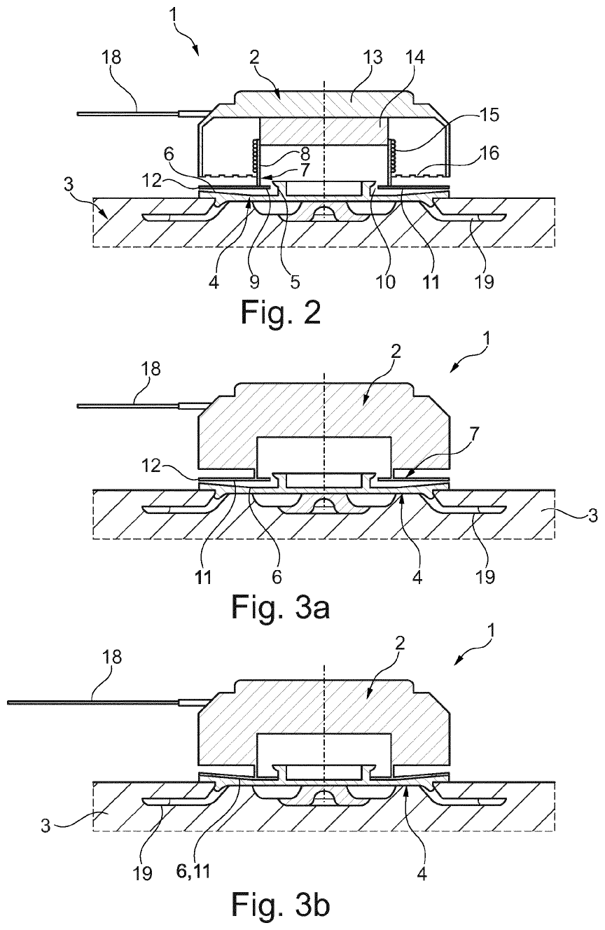

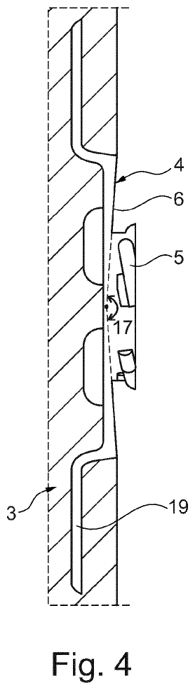

According to the represented embodiment, as illustrated in detail in FIG. 2, the transducer 2 comprises a cover 13 inside which a magnet 14 is attached, and an electrical coil 15, powered by cables 18, suspended from said cover by spring means 16.

Moreover, the interface 7 is attached—in particular by gluing—inside the coil 15.

According to one embodiment, the top of the cone defining the frusto-conical shape defines an angle 17 which is greater than 170°.

According to one embodiment, the angle 17 defined above is less than 178°, in particular by being greater than 170°.

According to the represented embodiment, the thread 5 and reciprocal thread 10 are fragmented into a plurality of angular sectors—here four—each being inscribed in a respective helix, so as to allow the complete screwing after a rotation of less than a half-turn—here of about a quarter turn.

Such an embodiment allows a minimisation of the axial space requirement and also a simplification of the mounting of the transducer 2 avoiding a twisting of the power cables 18 thereof.

In a manner which is not represented, the system 1 can comprise means of anti-unscrewing of the transducer 2 once attached, said means comprising two reciprocal stops which are respectively secured to the base 4 and the attachment interface 7, one of said stops being elastically retractable and being temporarily retracted at the end of screwing on approaching the other of said stops to be redeployed once the screwing has been finalised and cooperate with said other stop.

According to the represented embodiment, the base 4 is provided with anchor lugs 19 protruding radially outwards from the receiving track 6, so as to allow a reinforced attachment of said base to the panel 3.

A panel 3 equipped with a transducer 2 mounted by such a system 1 is now described, said equipped panel comprising, in addition to said panel and said transducer:
a base 4 attached—for example by overmoulding, by welding, etc. . . . —to said panel—which is for example based on moulded polyurethane, of moulded thermoplastics, thermo-compressed fibrous material, etc. . . . —, said base being provided with a thread 5 and a peripheral receiving track 6 having, in axial view, a shape of a washer,
an interface 7 made of moulded plastic material for attaching said transducer, said interface having:
   an association part 8 attached—for example by gluing—to said transducer,
   a part 9 for attaching to said base, said part being provided with a reciprocal thread 10 screwed onto said thread,
   a flexible collar defining a reciprocal track 11 having, in axial view, a shape similar to that of said receiving track,
      knowing that said receiving track is inscribed in a substantially flattened frusto-conical shape, said reciprocal track bearing by its surface on said receiving track to conform to the shape thereof.

According to a partially represented embodiment, the transducer 2 is connected to two power supply cables 18 intended to be connected to an amplifier provided in the peripheral environment of the panel 3, said cables being housed in a trench, which is not represented, provided in said panel.

What is claimed is:

1. A system for mounting a transducer on an interior trim panel of a motor vehicle, the system comprising:
a base configured to be attached to the interior trim panel, the base being provided with a thread and a receiving track having, in axial view, a shape of a washer,
an interface made of moulded plastic material configured to attach to the transducer, the interface having:
a first part configured for association with the transducer,
a second part configured for attaching to the base, the second part being provided with a reciprocal thread configured to be screwed onto the thread,
a flexible collar defining a reciprocal track having, in axial view, a shape similar to that of the receiving track,
the receiving track is inscribed in a substantially flattened frusto-conical shape configured such that:
before screwing and when the receiving track and reciprocal track are brought into contact with each other, the contact is made along a circular peripheral line, and
once the screwing is complete, the reciprocal track deforms to bear by its surface on the receiving track and to conform to the shape of the receiving track.

2. The system according to claim 1, wherein the peripheral receiving track includes a cone defining the frusto-conical shape, and the top of the cone defines an angle which is greater than 170°.

3. The system according to claim 2, wherein the top of the cone defining the frusto-conical shape defines an angle of less than 178°.

4. The system according to claim 1, wherein the thread and reciprocal thread are fragmented into a plurality of angular sectors each being inscribed in a respective helix, configured to permit-the complete screwing after a rotation of less than a half-turn.

5. The system according to claim 1, further including means of anti-unscrewing of the transducer once attached, the anti-unscrewing means comprising two reciprocal stops which are respectively secured to the base and the interface, one of the stops being elastically retractable and being temporarily retracted at the end of screwing on approaching the other of the stops to be redeployed once the screwing has been finalised and cooperate with the other stop.

6. The system according to claim 1, wherein the base is provided with anchor lugs protruding radially outwards from the receiving track, and configured to reinforce the attachment of the base to the panel.

7. A panel equipped with a transducer mounted by a system according to claim 1, the panel comprising, in addition to the panel and the transducer:
the base attached to the panel, the base being provided with a thread and a peripheral receiving track having, in axial view, a shape of a washer,
the interface attached to the transducer, the interface having:
the first part attached to the transducer,
the second part attached to the base, the second part being screwed onto the thread with the reciprocal thread,
the reciprocal track bearing by its surface on the receiving track to conform to the shape of the receiving track.

8. The panel according to claim 7, wherein the transducer is connected to two power supply cables configured to be connected to an amplifier provided in the peripheral environment of the panel, the cables being housed in a trench provided in the panel.
